(19) United States
(12) Patent Application Publication
(10) Pub. No.: US 2020/0256441 A1
(43) Pub. Date: Aug. 13, 2020

(54) BLADE ASSEMBLY WITH TABLESS BLADES

(71) Applicant: Schaeffler Technologies AG & Co. KG, Herzogenaurach (DE)

(72) Inventors: Randy Keller, Polk, OH (US); Rolf Mueller, Wooster, OH (US); Alexander Walton, Burbank, OH (US); Brian Riley, Wooster, OH (US)

(73) Assignee: Schaeffler Technologies AG & Co. KG, Herzogenaurach (DE)

(21) Appl. No.: 16/272,674

(22) Filed: Feb. 11, 2019

(51) Int. Cl. F16H 41/28; F01D 5/32

(52) U.S. Cl. CPC F16H 41/28; F05D 2230/237; F05D 2230/60; F01D 5/323

(57) ABSTRACT

A blade assembly is disclosed herein that avoids the issues associated with aligning mating parts formed on blades with the shell during assembly. The blade assembly disclosed herein eliminates the need for embossments or pierced slots on the shell, and the need for mating tabs on the blades. In one embodiment, the blade assembly includes a shell defining an inner surface, and a plurality of blades arranged around the inner surface of the shell. The plurality of blades each include at least one axially extending leg adapted to contact the inner surface of the shell, and the plurality of blades are attached to the shell via brazing.

### FIELD OF INVENTION

The present invention relates to a torque converter, and more specifically relates to a blade assembly for a torque converter.

### BACKGROUND

Torque converters include blade assemblies consisting of a shell, a core ring, and blades to direct fluid flow. The blades are arranged around a circumference of the shell and the core ring, and are typically attached to the shell by brazing.

It is known to provide positive fit connections between the blades and the shell to provide a secure connection between these components. This typically requires forming tabs on the blades and slots or pockets on the shell, and inserting the tabs into the slots or pockets during assembly. However, ensuring a proper fit between the blades and the shell is time consuming and labor intensive, and therefore expensive.

It would be desirable to make the blade assembly of a torque converter both easier to assemble and less expensive to assemble.

### SUMMARY

A blade assembly is disclosed herein that avoids the issues associated with aligning the blades with the shell during assembly. The blade assembly disclosed herein eliminates the need for embossments or pierced slots on the shell, and the need for mating tabs on the blades.

In one embodiment, the blade assembly includes a shell defining an inner surface, and a plurality of blades arranged around the inner surface of the shell. The plurality of blades each include at least one axially extending leg adapted to contact the inner surface of the shell, and the plurality of blades are attached to the shell via brazing.

In another embodiment, the blade assembly includes a shell defining an inner surface, a plurality of blades arranged around the inner surface of the shell, and a core ring. The plurality of blades each include a radially inner region including a first axially extending leg, a radially outer region including a second axially extending leg, and at least one radially extending tab. The first axially extending leg and the second axially extending leg of each of the plurality of blades abut the inner surface of the shell. The core ring includes a plurality of slots adapted to receive the at least one radially extending tab of each of the plurality of blades.

In another embodiment, a method of assembling a blade assembly for a torque converter is disclosed. The method includes providing: a shell defining an inner surface; a plurality of blades each including: a radially inner region including a first axially extending leg, a radially outer region including a second axially extending leg, and at least one radially extending tab; and a core ring including a plurality of slots adapted to receive the at least one radially extending tab of each of the plurality of blades. The method includes inserting the at least one radially extending tab of each of the plurality of blades into the slots of the core ring; positioning the plurality of blades around a circumference of the inner surface of the shell such that the first axially extending leg and the second axially extending leg of each of the plurality of blades abut against the inner surface of the shell; and brazing the plurality of blades to the shell.

Other variations of the blade assembly and method of assembling the blade assembly are disclosed in more detail herein.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a top view of a blade assembly according to an embodiment.

FIG. 2 is a perspective view of a cross section of the blade assembly of FIG. 1.

FIG. 3 is a front perspective view of a single blade from the blade assembly of FIGS. 1 and 2.

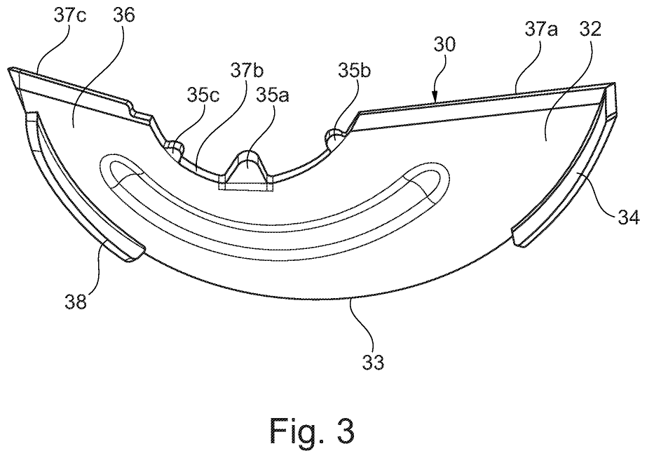

FIG. 4 is a rear perspective view of a single blade from the blade assembly of FIGS. 1 and 2.

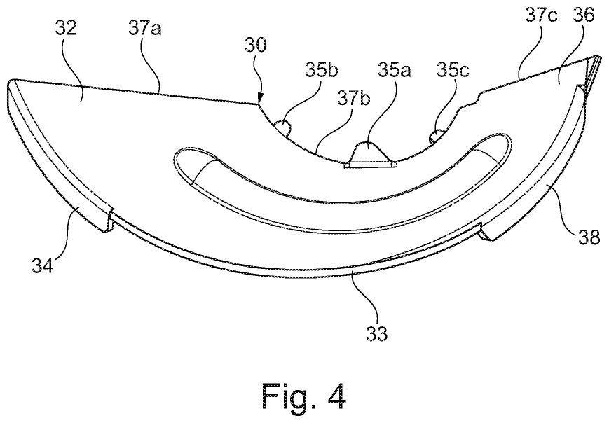

FIG. 5 is a planar view of a single blade from the blade assembly of FIGS. 1 and 2.

### DETAILED DESCRIPTION OF THE PREFERRED EMBODIMENTS

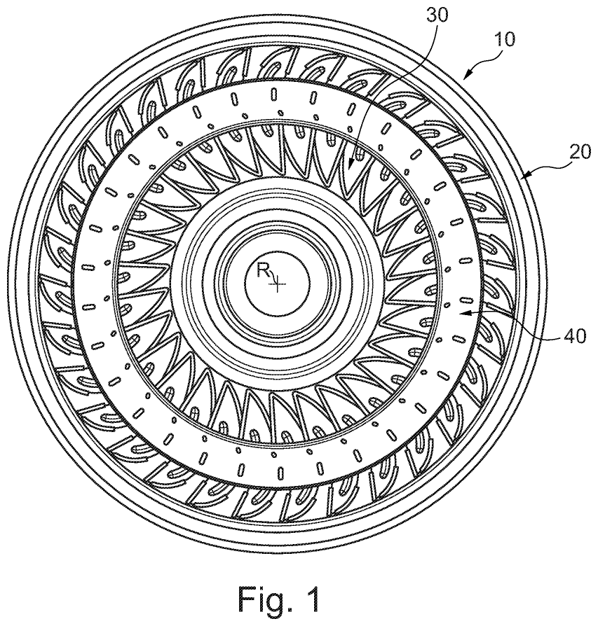

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import. The terms radial, axial, and circumferential are used with respect to a rotation axis (R) shown in FIG. 1.

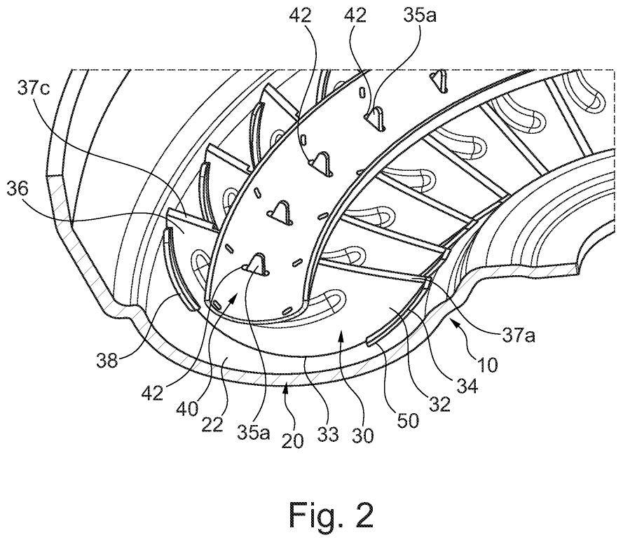

A blade assembly 10 for a torque converter is shown in FIGS. 1 and 2. The blade assembly 10 includes a shell 20 defining an inner surface 22, a plurality of blades 30 arranged around the inner surface 22 of the shell 20, and a core ring 40.

Each blade 30 includes a radially inner region 32 defining a first axially extending leg 34, a radially outer region 36 defining a second axially extending leg 38, and at least one radially extending tab 35a, 35b, 35c.

In one embodiment, the at least one radially extending tab 35a, 35b, 35c includes three tabs. In one embodiment, a middle tab 35a is larger than two side tabs 35b, 35c. One of ordinary skill in the art would understand that the number of tabs 35a, 35b, 35c can be varied depending on the particular requirements for a specific application.

The first axially extending leg 34 and the second axially extending leg 38 of the blade 30 each abut against the inner surface 22 of the shell 20. The legs 34, 38 each have a curved profile that has an identical curvature as the inner surface 22 of the shell 20. The legs 34, 38 provide a reliable, steady, and solid base for abutting the blades 30 against the shell 20, and an improved site for applying brazing material 50 to secure the blades 30 to the shell 20. The legs 34, 38 generally increase a surface area for contact between the blades 30 to the shell 20. The legs 34, 38 each have an axial width that is greater than a thickness of the blades 30.

As shown in the drawings, the first axially extending leg 34 and the second axially extending leg 38 both extend in the same axial direction. One of ordinary skill in the art would understand that the legs 34, 38 can extend in opposite axial directions while still providing the advantages of an improved attachment site for the blades 30 to the shell.

The core ring 40 includes a plurality of slots 42 adapted to receive the tabs 35a, 35b, 35c of the blades 30. The slots 42 can be of varying sizes and locations to accommodate the tabs 35a, 35b, 35c.

The shell 20 disclosed herein lacks any pierced openings or slots, and the inner surface 22 of the shell 20 has an uninterrupted profile, as best shown in FIG. 2. As used herein, the term uninterrupted profile with respect to the shell 20 means that the shell 20 has a continuous and uniform profile (i.e. no slots, opening, piercings, etc.) between a radially inner edge and a radially edge of the shell 20.

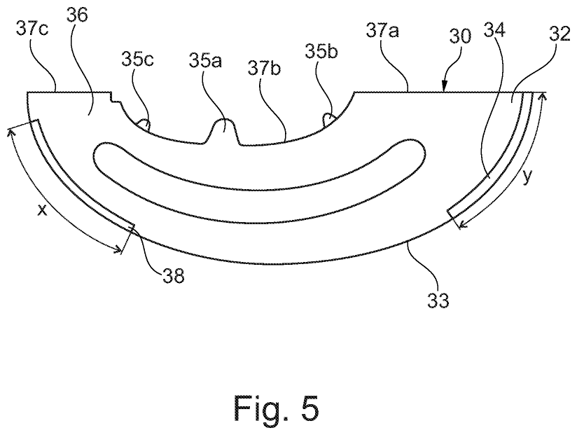

As shown in FIG. 5, the first axially extending leg 34 has a first circumferential extent (X), and the second axially extending leg 38 has a second circumferential extent (Y). In one embodiment, the first circumferential extent (X) and the second circumferential extent (Y) are within 50% of each other. In one embodiment, the first circumferential extent (X) and the second circumferential extent (Y) are within 25% of each other. In another embodiment, the first circumferential extent (X) and the second circumferential extent (Y) are within 10% of each other. In one embodiment, the first circumferential extent (X) and the second circumferential extent (Y) are identical. By providing extents (X, Y) that are relatively similar, the associated brazing sites provided by these extents (X, Y) are also relatively the same, which provides a more uniform load profile on the blades 30 during operating.

As shown in more detail in FIG. 5, each of the plurality of the blades 30 generally has a half-circular profile defining a continuously curved face 33 on a first side that is adapted to abut against the shell 20, and a second side including two flat leg faces 37a, 37c are connected by a curved region 37b. The first axially extending leg 34 contacts a first one of the two flat leg faces 37a, and the second axially extending leg 38 is spaced away from the two flat leg faces 37a, 37c. One of ordinary skill in the art would recognize that the exact position of the legs 34, 38 can be adjusted along the curved face 33 of the blades 33. The curved face 33 extends continuously between the first flat leg face 37a and the second flat leg face 37c. In one embodiment, the combined circumferential extents (X, Y) are at least 20% of a total circumferential extent of the curved face 33. In another embodiment, the combined circumferential extents (X, Y) are at least 40% of a total circumferential extent of the curved face 33.

In one embodiment, the blade assembly 10 includes the shell 20 defining the inner surface 22, and the plurality of blades 30 arranged around the inner surface 22 of the shell 20. The blades 30 include at least one axially extending leg 34, 38 (which can include a single leg) adapted to contact the inner surface 22 of the shell 20, and blades 30 are attached to the shell 20 via brazing 50.

A method of assembling a blade assembly 10 is also disclosed. The method includes the steps of providing the shell 20, blades 30, and core ring 40. The method further includes inserting the at least one radially extending tab 35a, 35b, 35c of each of the plurality of blades 30 into the slots 42 of the core ring 40, positioning the plurality of blades 30 around a circumference of the inner surface 22 of the shell 20 such that the first axially extending leg 34 and the second axially extending leg 38 of each of the plurality of blades 30 abut against the inner surface 22 of the shell 20; and brazing 50 the plurality of blades 30 to the shell 20.

The blades 30 lack a positive fit connection with the shell 20. The blades 30 only include a single set of tabs 35a, 35b, 35c (only on one side of the blades 30) for mating with the core ring 40. The blades 30 lack any mating tab for connection with the shell 20, and therefore assembly of the blades 30 with the shell 20 is simplified compared to existing arrangements. The sole connection between the blades 30 and the shell 20 is accomplished via the brazing 50 and no other connection means are required to join the blades 30 and the shell 20. By increasing a surface contact area between the blades 30 and the shell 20, the brazing connection 50 is strong enough to ensure a reliable connection between the blades 30 and the shell 20. One of ordinary skill in the art recognizes that the core ring 40 can be omitted.

Having thus described the present invention in detail, it is to be appreciated and will be apparent to those skilled in the art that many physical changes, only a few of which are exemplified in the detailed description of the invention, could be made without altering the inventive concepts and principles embodied therein.

It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

### LOG OF REFERENCE NUMERALS

Blade assembly 10

Shell 20

Inner surface 22

Blades 30

Radially inner region 32

Curved face 33

Axially extending legs 34, 38

Radially extending tab 35a, 35b, 35c

Radially outer region 36

flat leg faces 37a, 37c

curved region 37b

Core ring 40

Slots 42

Brazing material 50

What is claimed is:

1. A blade assembly for a torque converter, the blade assembly comprising:
a shell defining an inner surface,
a plurality of blades arranged around the inner surface of the shell, the plurality of blades each including at least one axially extending leg adapted to contact the inner surface of the shell, and the plurality of blades being attached to the shell via brazing.

2. The blade assembly of claim 1, wherein the at least one leg includes a first leg and a second leg, with the first leg arranged on a radially inner region of each blade of the plurality of blades, and the second leg arranged on a radially outer region of each blade of the plurality of blades, and the first leg and the second leg each abut the inner surface of the shell.

3. The blade assembly of claim 2, wherein the first leg has a first circumferential extent, and the second leg has a second circumferential extent, and the first circumferential extent and the second circumferential extent are within 50% of each other.

4. The blade assembly of claim 2, wherein the first leg and the second leg both extend in the same axial direction.

5. The blade assembly of claim 1, wherein each blade of the plurality of blades further comprises at least one radially extending tab.

6. The blade assembly of claim 5, further comprising a core ring including a plurality of slots adapted to receive the at least one radially extending tab of each of the plurality of blades.

7. The blade assembly of claim 1, wherein the shell lacks slots, and the inner surface has an uninterrupted profile.

8. The blade assembly of claim 1, wherein the at least one axially extending leg has a continuously curved profile.

9. The blade assembly of claim 1, wherein the plurality of blades lack a positive fit connection with the shell.

10. A blade assembly for a torque converter, the blade assembly comprising:
a shell defining an inner surface,
a plurality of blades arranged around the inner surface of the shell, the plurality of blades each including:
a radially inner region including a first axially extending leg,
a radially outer region including a second axially extending leg, and
at least one radially extending tab,
the first axially extending leg and the second axially extending leg of each of the plurality of blades abut the inner surface of the shell, and
a core ring including a plurality of slots adapted to receive the at least one radially extending tab of each of the plurality of blades.

11. The blade assembly of claim 10, wherein the first axially extending leg and the second axially extending leg both extend in the same axial direction.

12. The blade assembly of claim 10, wherein the plurality of blades are connected to the shell by brazing.

13. The blade assembly of claim 10, wherein the shell lacks slots, and the inner surface has an uninterrupted profile.

14. The blade assembly of claim 10, wherein the first axially extending leg has a first circumferential extent, and the second axially extending leg has a second circumferential extent, and the first circumferential extent and the second circumferential extent are within 50% of each other.

15. The blade assembly of claim 10, wherein each of the plurality of the blades has a first side with a half-circular profile defining a continuously curved face that is adapted to abut against the shell, and a second side consisting of two flat leg faces connected by a curved region.

16. The blade assembly of claim 15, wherein the first axially extending leg contacts a first leg face of the two flat leg faces, and the second axially extending leg is spaced away from the two flat leg faces.

17. A method of assembling a blade assembly for a torque converter, the method comprising:
providing:
a shell defining an inner surface,
a plurality of blades each including:
a radially inner region including a first axially extending leg,
a radially outer region including a second axially extending leg, and
at least one radially extending tab; and
a core ring including a plurality of slots adapted to receive the at least one radially extending tab of each of the plurality of blades;
inserting the at least one radially extending tab of each of the plurality of blades into the slots of the core ring;
positioning the plurality of blades around a circumference of the inner surface of the shell such that the first axially extending leg and the second axially extending leg of each of the plurality of blades abut against the inner surface of the shell; and
brazing the plurality of blades to the shell.
